(19) United States
(12) Patent Application Publication
(10) Pub. No.: US 2008/0090588 A1
(43) Pub. Date: Apr. 17, 2008

(54) Positioning system

(76) Inventors: Kenichi Mizugaki, Kodaira (JP); Tatsuo Nakagawa, Kokubunji (JP); Ryosuke Fujiwara, Kodaira (JP)

Correspondence Address: REED SMITH LLP, Suite 1400, 3110 Fairview Park Drive, Falls Church, VA, 22042, US

(21) Appl. No.: 11/902,483

(22) Filed: Sep. 21, 2007

(30) Foreign Application Priority Data
Oct. 13, 2006 (JP) 2006-279448

(51) Int. Cl. H04Q 7/20; H04M 1/00

(52) U.S. Cl. 455/456.1; 455/561

(57) ABSTRACT

A positioning system having a node (subject to positioning) transmitting a positioning signal; a reference station transmitting a reference signal; at least three base stations having a receiving part receiving the aforementioned positioning signal and the aforementioned reference signal; and a server connected to the base stations by a network;
wherein the aforementioned server measures, using a clock signal and a signal shifting the concerned clock signal, the time difference with which the aforementioned positioning signal and the aforementioned reference signal are received by the aforementioned plurality of base stations as well as the frequency deviation with the aforementioned base stations;
decides whether to carry out a correction with respect to the aforementioned measured time difference, on the basis of the measurement result of the aforementioned positioning signal; and
computes the position of the aforementioned node, based on the aforementioned time deviation for which appropriate processing has been performed.

### INCORPORATION BY REFERENCE

The present application claims priority from Japanese application JP2006-279448 filed on Oct. 13, 2006, the content of which is hereby incorporated by reference into this application.

### BACKGROUND OF THE INVENTION

The present invention pertains to a receiving device suitable for measuring the position of a terminal node having a radio communication function, a frequency deviation measuring unit, and a positioning system using the same.

Wireless Sensor Networks (hereinafter abbreviated as “sensornet”) which, by means of the fact that devices having a sensing function are installed within the surrounding region and that the sensing devices constitute the network by radio, efficiently bring in real-world information to information networks such as the Internet, are gaining attention. This sensornet is a concept whereby innumerable nodes (terminals) comprising a sensor, a microcomputer, a radio communications device, and a power supply measure the conditions of people, things, the environment, or the like, by means of sensors and autonomously constitute the network. Application to various fields like distribution, automobiles, agriculture, and the like, are being investigated.

For the purpose of the implementation of a sensornet, there is a need to install nodes at physical objects and to detect continuously and for a long time. To that end, it is demanded of the nodes to have small size and low power consumption. Also, in order to arrange a number of nodes in a distributed manner, node management becomes important technology.

On the other hand, even for radio communications meant for sensornets, low-power communications technology is after all requested. Ultra Wide Band (hereinafter abbreviated as “UWB”) communication devices have low power consumption and have the possibility of being small-scale, so hopes are being placed thereon as communication devices meant for sensornets. UWB radio communications are defined as a method using radio waves devised to have a bandwidth of 500 MHz or greater, or to have a ratio of bandwidth to center frequency of 20 percent or greater. UWB communications spread data over a very broad bandwidth to carry out transmission and reception, the signal energy per unit frequency bandwidth being very small. Consequently, communication becomes possible without causing interference to other communication systems and sharing of frequency bands becomes possible.

As an example of UWB communications, a UWB-IR (Ultra Wide Band-Impulse Radio) communication system, in which Gaussian monopulses are modulated with the PPM (Pulse Position Modulation) system, is disclosed in Moe Z. Win et al, “Impulse Radio: How It Works”, IEEE Communications Letters, Vol. 2, Issue 2, pp. 36-38 (February 1998). As a method of implementing the synchronization with pulse signals like these, there is e.g. known the method of shifting the template pulse generation timing with a prescribed interval and taking the correlation.

Also, as a position measurement system, there is known the technology of receiving the signal from a node with a plurality of base stations and computing the node position by utilizing the Time Difference of Arrival (TDOA).

In e.g. JP-A-2005-140617, there is disclosed a method wherein base stations measure the reception time differences of the positioning signal from the node and a reference signal from a reference station, and position by utilizing TDOA on the basis of the same reception time differences.

### SUMMARY OF THE INVENTION

One issue in positioning systems is the improvement of the positioning accuracy. In the system mentioned in JP-A-2004-258009, there is a need for a high-speed oscillator and a high-speed counter for the purpose of improving the positioning accuracy. Also, the transceiver is provided with separate clock generators respectively generating the clocks of prescribed frequencies, but the ranging accuracy is influenced by the accuracy and stability of each clock generator of the transceiver. I.e., the frequency deviation of each oscillator of the transceiver becomes a primary error factor in the ranging accuracy.

In the system mentioned in JP-A-2004-254076, it becomes possible to detect a change in the distance between transceivers, but the position of a transmitter cannot be specified. Also, the transceiver is provided with separate clock generators respectively generating clocks of prescribed frequencies, but the accuracy specifying a change in the distance is influenced by the accuracy and stability of each clock generator of the transceiver. I.e., the frequency deviation of each oscillator of the transceiver becomes a primary error factor of the ranging accuracy.

Even in a system that positions by utilizing the TDOA mentioned in JP-A-2005-140617, the measurement accuracy of the time difference of arrival is influenced by the positioning accuracy. Generally, for a highly accurate time difference measurement, a high-speed oscillator and a high-speed counter become necessary, but the electric power consumption and the circuit scale end up increasing. Also, the accuracy of a time difference measurement depends on the frequency accuracy and stability of the oscillator. That is to say that the frequency deviation of the oscillator becomes a primary error factor of the time difference measurement. However, highly accurate and stable oscillators are expensive, so the cost of the device ends up increasing.

On the other hand, for a positioning system, a reduction in power consumption, miniaturization, and cost reduction are demanded. Consequently, for the purpose of highly accurate time difference measurements, it is not desirable to have a method using high-speed, highly accurate, and stable oscillators and high-speed counters.

It is an object of the present invention to devise, in a system measuring time differences and carrying out positioning, highly accurate time difference measurements so that they can be carried out with a device having low power consumption, small size, and low cost.

Among the inventions disclosed in the present application, if the outline of a representative system is briefly described, it is as follows.

The present invention is a receiving device receiving transmission signals from a transmitting device and comprising: a receiving part receiving the aforementioned transmission signals; an A/D conversion part making an analog-to-digital conversion of the aforementioned transmission signals; a phase shifting part shifting the phase of the timing with which the aforementioned A/D conversion part makes the analog-to-digital conversion; and a time difference and deviation measuring unit using the values time-shifted in the aforementioned phase shifting part to measure the time difference of reception of a first transmission signal and a second transmission signal as well as the clock deviation of the transmitter transmitting each signal.

According to the present invention, it becomes possible to carry out highly accurate time difference measurements using low-speed clocks, control signals, and counters, so highly accurate measurements are implemented with a device having low power consumption, small size, and low cost without using high-speed and highly accurate clocks and counters.

Other objects, features and advantages of the invention will become apparent from the following description of the embodiments of the invention taken in conjunction with the accompanying drawings.

### BRIEF DESCRIPTION OF THE DRAWINGS

FIG. 1 is an example of a block diagram of a positioning system related to Embodiment 1 of the present invention.

FIG. 2A is a block diagram showing a configuration example of a node (NOD) of Embodiment 1.

FIG. 2B is a block diagram showing a configuration example of a reference station (RS) of Embodiment 1.

FIG. 2C is a block diagram showing a configuration example of a base station (AP) of Embodiment 1.

FIG. 2D is a block diagram showing a configuration example of a positioning server of Embodiment 1.

FIG. 3 is an example of a sequence diagram showing an outline of the transmission and reception of signals occurring in the positioning system of Embodiment 1.

FIG. 4 is an example of a circuit block diagram of a receiving device related to Embodiment 1 of the present invention.

FIG. 5 is a circuit block diagram showing an example of a configuration of a baseband part having a time difference measuring function of a receiving device related to Embodiment 1 of the present invention.

FIG. 6 is a circuit block diagram showing an example of a configuration of the time difference measuring part of FIG. 5.

FIG. 7 is an example of a diagram describing the principle of a positioning system related to the present invention.

FIG. 8 is an example of a block diagram of a positioning signal transmitted from a node related to the present invention and a reference signal transmitted from a reference station related to the present invention.

FIG. 9 is an example of a diagram describing a synchronization capture method related to the present invention.

FIG. 10 is an example of a diagram describing a synchronization tracking method related to the present invention.

FIG. 11 is an example of a diagram describing a time difference measurement method related to the present invention.

FIG. 12 is an example of a diagram showing an overall flowchart of measurement processing according to Embodiment 1 of the present invention.

FIG. 13 is an example of a diagram showing a deviation measurement method related to Embodiment 1 of the present invention.

FIG. 14 is an example of a circuit block diagram of a transceiver device related to Embodiment 2 of the present invention.

### DETAILED DESCRIPTION OF THE INVENTION

Embodiments of a receiving device and a measurement system related to the present invention will hereinafter be described in detail using the accompanying drawings.

### First Embodiment

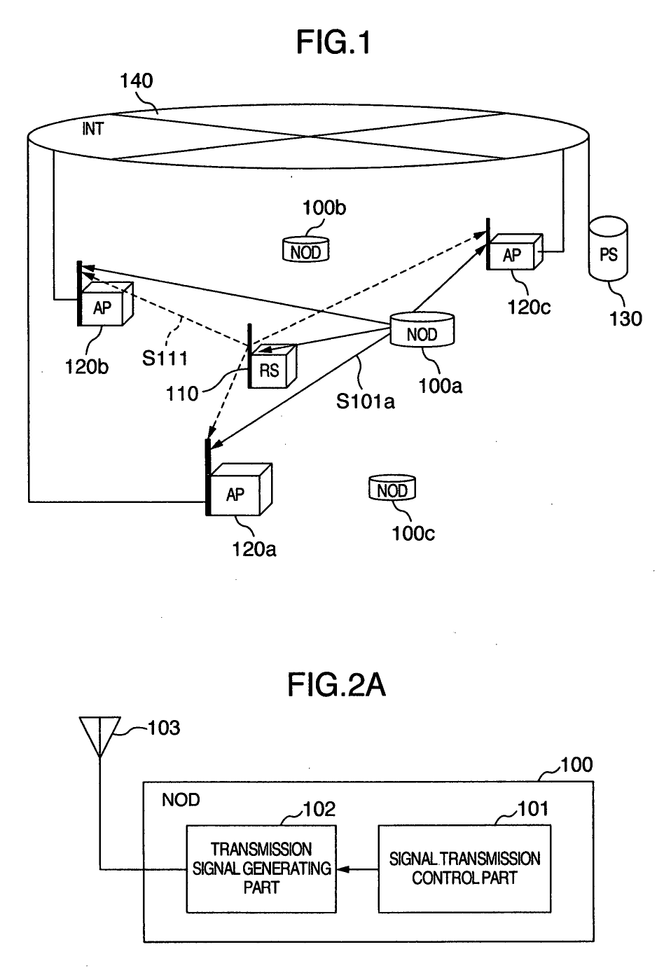

In FIGS. 1 to 12, inclusive, a description regarding a receiving device and a positioning system using the same, related to Embodiment 1 of the present invention, is given. First, a description regarding an outline of the configuration and operation of the system of Embodiment 1 is given in FIGS. 1 to 3, inclusive.

FIG. 1 shows the configuration of a positioning system related to Embodiment 1 of the present invention. The positioning system is composed of a plurality of nodes (NOD) 100 (100a, 100b, . . . ) (being the object of the positioning) that transmit positioning signals, a reference station (RS) 110 transmitting reference signals, a plurality of base stations (AP) 120 (120a, 120b, and 120c) receiving positioning signals and reference signals, a positioning server (PS) 130, and a network (INT) 140 connecting each base station 120 and positioning server 130. Further, the reference numeral indices a, b, and c are taken to indicate the same kind of constitutive element and, in case the indices are omitted, refer to an identical constitutive element. Also, the NOD are provided with at least a transmitting function, the RS is provided with a transmitting and receiving function, the AP are provided with at least a receiving function and a network connecting function, and the PS is provided with a network connecting function, but in order to simplify the description, there is here given a description wherein all are taken to have the transmitting and receiving functions necessary for the embodiments of the present invention.

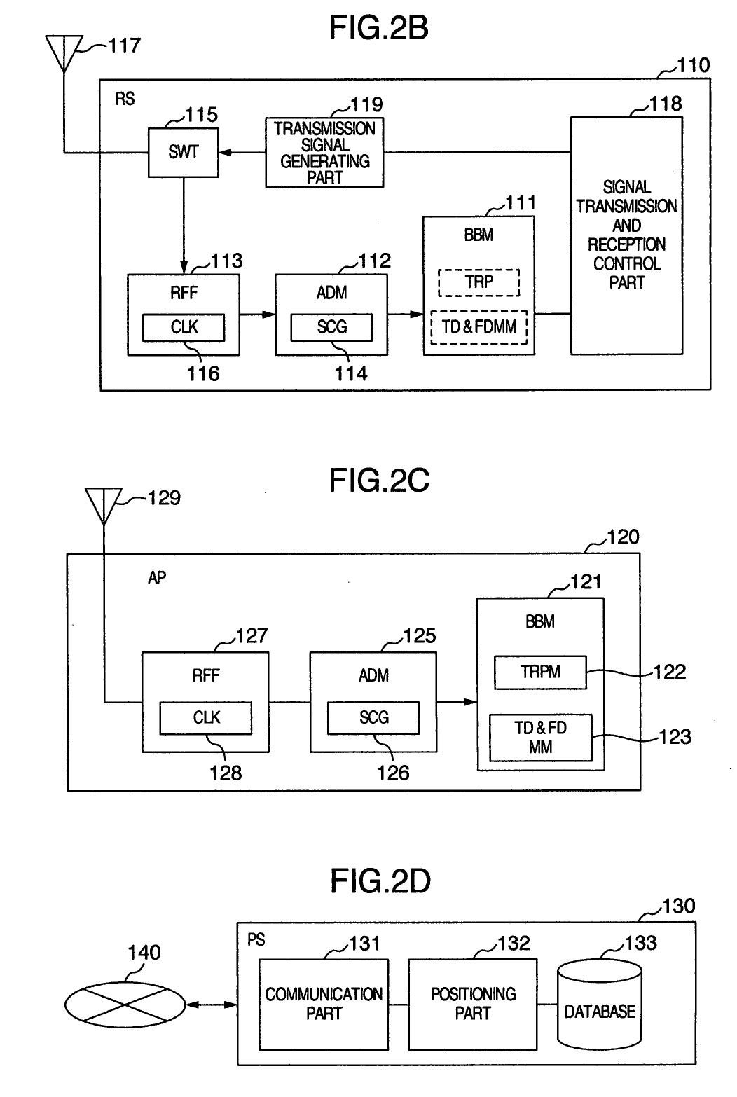

Outlines of configuration examples of each element constituting the system of Embodiment 1 are described with FIG. 2 (FIG. 2A to FIG. 2D).

FIG. 2A is a block diagram showing a configuration example of a node (NOD) 100. Each node is provided with a signal transmission control part 101, a signal generating part 102, and an antenna 103. As for signal transmission control part 101, based on information and the like from sensors and timers built into the node itself or connected thereto, the same node receives a command from signal transmission control part 101, generates a positioning signal S101, and transmits it from antenna 103. This positioning signal includes information such as an ID individually allocated to each node, making it possible to identify the positioning signals transmitted by each node.

FIG. 2B is a block diagram showing a configuration example of reference station (RS) 110. The reference station is composed of a baseband part (BBM) 111, an analog-to-digital conversion part (hereinafter abbreviated as “A/D conversion part”) (ADM) 112, an RF front-end part (RFF) 113, a transmission/reception switch (SWT) 115, an antenna (ANT) 117, a signal transmission and reception control part 118, and a transmission signal generating part 119. ADM 112 and RFF 113 have respectively an SCG 114 and a CLK 116 as generation sources of the clock signal to be synchronized. The reference station is provided with a function of transmitting, when receiving positioning signal S101 transmitted by node 100, reference signal S111 generated in transmission signal generating part 119.

FIG. 2C is a block diagram showing a configuration example of base station (AP) 120. The base station is composed of a baseband part (BBM) 121, an analog-to-digital conversion part (ADM) 125, an RF front-end part (RFF) 127, and an antenna (ANT) 129. ADM 125 and RFF 127 respectively have an SCG 126 and a CLK 1128 as generation sources of the clock signal to be synchronized. Baseband part 121 is provided with a function of specifying the node or the reference station having transmitted the concerned signal, on the basis of information in which it is possible to specify the transmitting station and which is included in the received signal. Further, baseband part 121 is also provided with a synchronization capture part (TRPM) 122 generating a shift signal changing the phase of a clock signal generated in the SCG, changing the phase of the clock signal, and carrying out capture of synchronization between the transmission signal and the aforementioned clock signal; and a time difference and deviation measuring part (TD&FDMM) 123 measuring, using the clock signal and the shift signal, the time difference with which the positioning signal and the reference signal are received, as well as the clock frequency deviation between the reference station and the base station itself.

Further, as shown in FIG. 2B, the communication device constituting reference station (RS) 110 may also be devised, similarly to base station (AP) 120, to be provided with a synchronization capture part (TRPM) and a time difference and deviation measuring part (TD&FDMM). Also, a transmission function similar to that of reference station (RS) 110 may be provided to base station (AP) 120 as well.

FIG. 2D is a block diagram showing a configuration example of positioning server (PS) 130. The positioning server is provided with a communication part 131, a positioning part 132, and a system information database 133 storing positioning information of each base station and reference station. Communication part 131 functions as an interface connecting the positioning server to network 140, receives positioning information reports sent from the base stations and sends the same to positioning part 132. Positioning part 132 computes the position of node 100 on the basis of time difference of reception information of signals included in the positioning information report and found in the base station, and position information about each base station and reference station that is obtained from system information database 133.

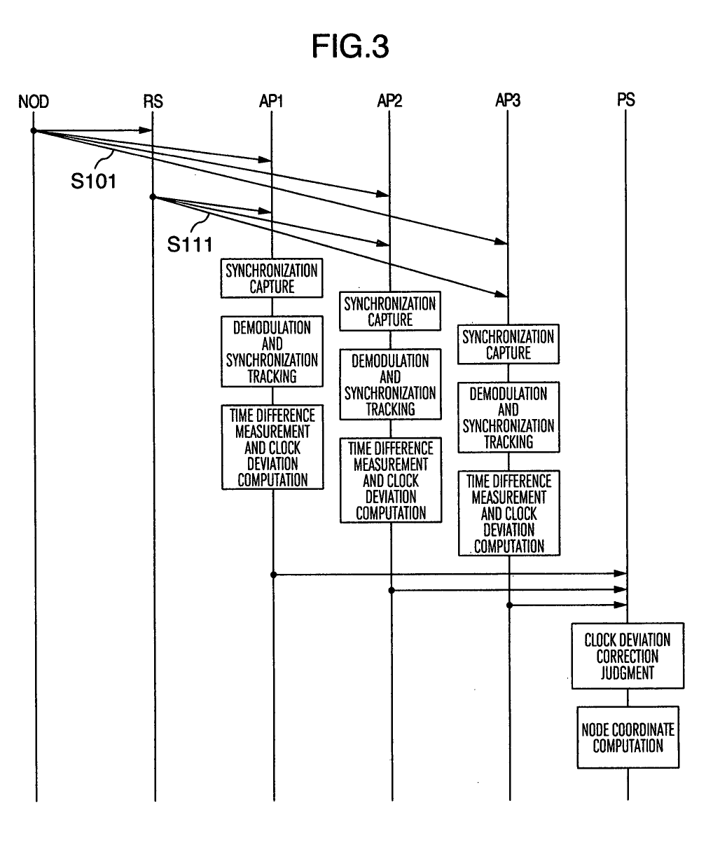

FIG. 3 is a sequence diagram showing the outline of the transmission and reception of signals found in the positioning system of the present embodiment.

At an arbitrary time at which a position calculation, based on an instruction from the server, the track of a preset timer, or the like, is desired, the node transmits a transmission signal including a positioning signal S101 with respect to reference station 110 and base stations 120 in the surrounding region. Reference station 110, after receiving the positioning signal, transmits a transmission signal including reference station signal S111. Each base station measures and calculates positioning information, e.g. the time difference between the time of reception of the positioning signal and the time of reception of the reference signal, as well as ID and other information for identifying the base station, and the clock frequency deviation, and sends it to server 130 via the network.

Here, each base station 120, when receiving the transmission signal, carries out capture of synchronization between this transmission signal, e.g. a positioning signal, and a sampling clock. After the synchronization capture has been established, demodulation and synchronization tracking of the transmission signal are carried out. Each base station, in parallel with the processing of the reception of transmission signals such as synchronization capture, demodulation and synchronization tracking, carries out the processing of measuring the time difference of reception of the positioning signal and the reference signal and the processing of measuring the frequency deviation between the clocks of the reference station and the base station itself, and sends information based on the result thereof to server 130.

At this point, a method in which each base station sends the measured data unchanged to the server and the server uses data all together from each base station and computes the time difference of reception and the clock deviation is also in the category of the present invention.

Server 130 judges from these pieces of information whether

to carry out a correction of the clock frequency deviation of each base station with respect to the difference of reception of each base station, processes the time difference of reception data on the basis thereof, and, based on the same time difference of reception data and the information registered in a database held by the server, calculates the coordinates of the node to carry out positioning.

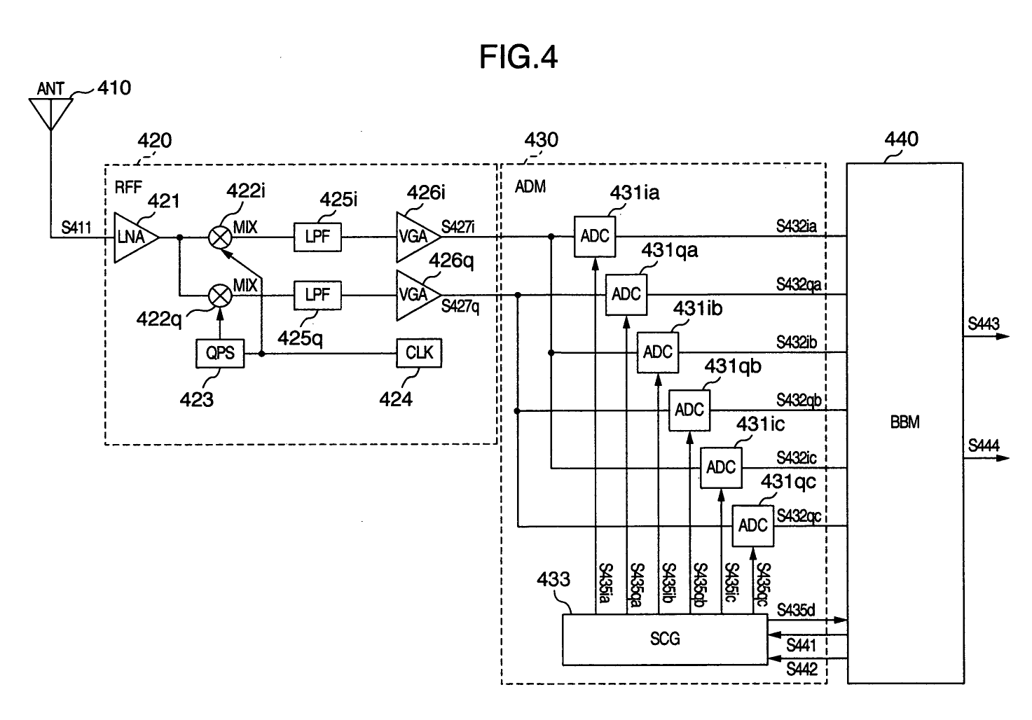

Next, regarding the specific configuration, the operating principle, workings, and effect of a system of Embodiment 1, a description will be given with FIGS. 4 to 12, inclusive.

First, the receiving device in base station 120 related to the present invention is constituted by a UWB-IR receiving device receiving intermittent pulse sequences, such as e.g. shown in FIG. 4.

In transmitting devices existing individually with space left in between, e.g. BPSK (Binary Phase Shift Keying) modulated and directly spread pulse sequences are transmitted in space, and the pulse sequence signal gradually propagating in space is received with the antenna of the present receiving device. The signal propagating in space is an impulse sequence that is transmitted with e.g. a pulse width of approximately 2 ns and intervals of approximately 30 ns. The shape of the impulses takes e.g. the primary Gaussian shape, there being further used a shape that is up-converted by means of a carrier wave at approximately 4 GHz.

The receiving device is composed of an antenna (ANT) 410, an RF front-end part (RFF) 420, an analog-to-digital conversion part (hereinafter abbreviated as “A/D conversion part”) (ADM) 430, and a baseband part (BBM) 440.

RF front-end part 420 is composed of a Low Noise Amplifier (LNA) 421, mixers (MIX) 422i and 422q, a n/2 phase shifter (QPS) 423, a clock generator (CLK) 424, a Low Pass Filters (LPF) 425i and 425q, and Variable Gain Amplifiers (VGA) 426i and 426q.

Further, the indices i and q are respectively indicated for I (In Phase) signal components and Q (Quadrature) signal components, and in the description hereinafter, the i and q are omitted where not particularly needed.

The pulse signal (an intermittent pulse sequence) received from antenna 410 is, after having been amplified in Low Noise Amplifier 421, supplied to mixer 422. In mixer 422, the approximately 4 GHz clock signal generated by clock generator 424 is supplied, so, as a result, the output of mixer 422 is separated into a 4 GHz carrier wave and an impulse signal with a Gaussian shape having a pulse width of approximately 2 ns. At this point, in mixer 422i, the output signal of clock generator 424 is supplied directly and the I signal, which is the in-phase output signal, is output. On the other hand, in mixer 422q, since the clock signal of clock generator 424 passes through n/2 phase shifter (QPS) 423 and a clock signal having the phase delayed by n/2 is supplied, the output signal becomes the Q signal which is the quadrature component.

The signals separated in mixers 422 are discriminated with Low Pass Filters 425 and the high-frequency 4 GHz carrier wave is blocked. Consequently, only the Gaussian impulse shape is output from Low Pass Filters 425. These impulse signals are amplified in Variable Gain Amplifiers 426 and are output from RF front-end part 420 as respectively an I signal S427i and a Q signal 427q.

A/D conversion part 430 is composed of an A/D converter (ADC) 431 and a sampling clock generating part (SCG) 433, and input I signal S427i and Q signal S427q, being the output signals of the RF front-end part are input thereinto, converted into a digital signal by A/D converter ADC 431, and output.

Input signals S427i and S427q are respectively divided up into pluralities of signals, supplied to separate internal A/D converters 431, and converted into digital signals S432. In each A/D converter 431, the sampling timing for converting input signals S427 into digital values is controlled by means of sampling clocks S435. Sampling clocks S435 are supplied from sampling clock generating part 433, the period thereof being equal to the pulse repetition frequency of the received impulse sequences. That is to say that the sampling is carried out with a timing that is synchronized with the pulses of the impulse sequence.

However, the transmitting devices and the receiving devices exist separately with space left in between, so it is not the case that they are respectively synchronized. Because of that, the phases of the received impulse sequences and the sampling clocks do not match. Consequently, the operation of synchronization capture, making the phases of the received impulse sequences and the sampling clocks match, becomes necessary.

Here, it will be explained that there are two types of clock signals to be synchronized. The first is the 4 GHz frequency clock signal used in RF front-end part RFF 420 of FIG. 4 and the second is a clock signal used in A/D conversion part 430 with a frequency of approximately 32 MHz and corresponding to the fact that the impulse sequences are sent with intervals of approximately 30 ns.

As for the 4 GHz signal component, the signal received in RF front-end part RFF 420 is divided up into an I component and a Q component and the signal is restored in the baseband part BBM, and by means of this method, it becomes possible to respond without obtaining synchronization relative to the phase differences.

On the other hand, regarding the impulse sequence having a spacing of approximately 32 MHz, there is a need to carry out synchronization capture and synchronization tracking, as will be described hereinafter.

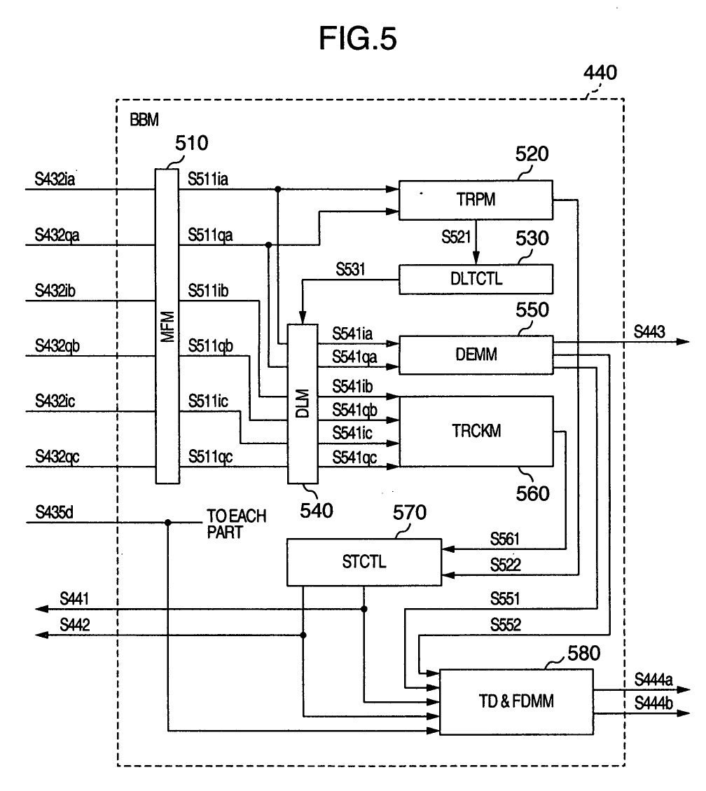

In FIG. 5, there is shown a block diagram of a baseband part 440. Baseband part 440 is composed of a matched filter part (MFM) 510, a synchronization capture part (TRPM) 520, a data holding timing control part (DLTCTL) 530, a data holding part (DLM) 540, a demodulation part (DEMM) 550, a synchronization tracking part (TRCKM) 560, a sampling timing control part (STCTL) 570, and a time difference and deviation measurement part (TD&FDMM) 580.

As for the I and Q signals S432ia to S432ic and S432qa to S432qc, supplied from A/D conversion part 430, the extent of matching with the spreading code synchronized in matched filter 510 is detected and the measurement result is output as a signal S511.

Synchronization capture part 520 carries out synchronization capture of the received signal (impulse sequence) using signals S511ia and S511qa. While the synchronization capture is not established, a signal S522 is outputted to sampling timing control part 570 and, using sampling timing control signals S441 and S442, the timing with which A/D conversion part 430 digitally converts the received signal is gradually changed. If synchronization capture is established, the synchronization timing information is transmitted to data holding timing control part 530 via signal S521.

Data holding timing control part 530 supplies control signal S531 to data holding part 540 with the timing for which synchronization has been obtained with received signal S511 and data holding part 540 transmits, as a signal S541, only those data which match the same timing to demodulation part 550 and synchronization tracking part 560. In demodulation part 550, the data are demodulated based on signal S541 chosen by means of data holding part 540 and digital data S443 are outputted.

Also, in synchronization tracking part 560, it is detected, based on signal S541 chosen by means of data holding part 540, whether synchronization deviation with received signal S427 is occurring, and in case synchronization deviation is occurring, the digital conversion timing of A/D conversion part 430 is adjusted through sampling timing control part 570 by means of sampling timing control signals S441 and S442.

In sampling timing control part 570, the digital conversion timing of A/D conversion part 430 is adjusted, based on signals from synchronization capture part 520 and synchronization tracking part 560. In case signal S522 is output from synchronization capture part 520, sampling timing control signal S441 is outputted via sampling timing control part 570 and the digital conversion timing is delayed more than normal by a very short time, e.g. on the order of 0.5 ns. That is to say that the normal digital conversion period (chosen to be T_{ck}) is equal to the impulse interval, but in case the concerned signal S441 is outputted, the interval of the digital conversion becomes T_{ck}+Tₛ. Note, however, that Tₛ is the timing shift time of the digital conversion in the case that the concerned signal S441 is output.

Also, the timing of the digital conversion is adjusted in response to an output signal S561 of synchronization tracking part 560. In case the digital conversion timing is advanced with respect to the analog signal S427 input into A/D conversion part 430, this is detected by synchronization tracking part 520 and transmitted to sampling timing control part 570 and control signal S441 is outputted and the digital conversion timing is delayed by Tₛ more than normal. In case, on the contrary, the digital conversion timing is delayed with respect to the analog signal S427, control signal S442 is output and the digital conversion timing is advanced by Tₛ more than normal.

That is to say that in case control signal S441 is outputted from sampling timing control part 570, the period of sampling clock S435 becomes T_{ck}+Tₛ for only one period, and in case control signal S442 is outputted, the period of S435 becomes T_{ck}−Tₛ for only one period. By controlling the period of sampling clock S435 in this way, synchronization capture and synchronization tracking become possible.

The basic operation of the UWB-IR communication receiving device receiving the pulse signals is as follows. That is to say that by receiving the pulse signal at antenna 410, extracting the reshaped waveform at the needed frequency in RF front-end part 420, converting it into a digital signal in A/D conversion part 430, and carrying out digital signal processing in baseband part 440, communication data S443 are picked out and output.

In baseband part 440 in the UWB-IR receiving device of the present embodiment, there is added for positioning time difference and deviation measurement part 580. The present time difference and deviation measurement part 580 is a part that implements highly accurate measurements with low power consumption, is a function provided from the outset in the receiving device that uses a comparatively low-speed counter and carries out highly accurate time difference measurements.

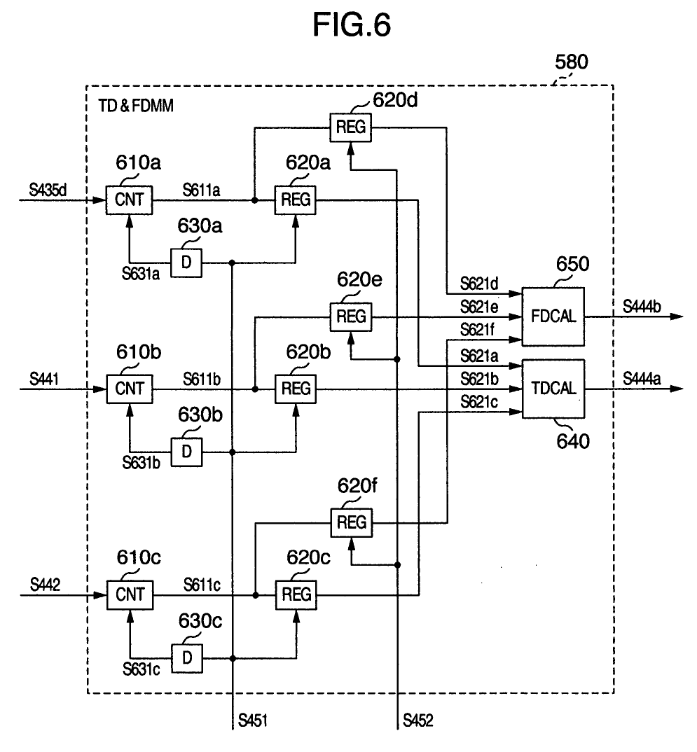

A specific configuration example of the time difference measurement part carrying this time difference measurement is shown in FIG. 6. Time difference and deviation measurement part 580 is composed of counters (CNT) 610, registers (REG) 620, delay parts (D) 630, a time difference calculation part (TDCAL) 640, and a deviation calculation part 650. Further, a description will be given subsequently regarding the details of time difference and deviation measurement part 580.

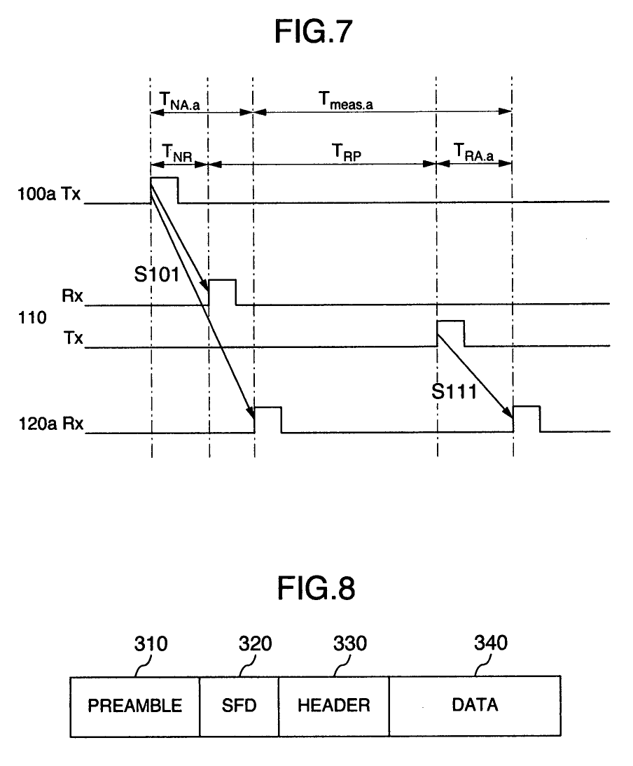

The workings of the positioning system of this embodiment will be described in greater detail while making reference to FIGS. 7 to 8, inclusive, using the example of the case wherein node 100a carries out a position measurement.

First, by FIG. 7, the principle of a positioning system related to the present invention will be described.

In FIG. 7, Tx indicates transmission and Rx indicates reception. Positioning signal S101 transmitted by node 100a is received after a time T_{NR} in reference station 110 and is received T_{NA,a} later in base station 120a. Reference station 110 transmits reference signal S111 a time T_{RP} after receiving positioning signal S101. A time T_{RA}, after being transmitted, reference signal S111 is received in base station 120a.

Base station 120a, after receiving positioning signal S101, measures the time T_{meas,a} until receiving reference signal S111.

T_{NR}+T_{RP}+T_{RA,a}=T_{NA,a}+T_{meas,a} (1a)

Also, positioning signal S101 and reference signal S111 are also received at base stations 120b and 120c, so

T_{NR}+T_{RP}+T_{RA,b}=T_{NA,b}+T_{meas,b} (1b)

T_{NR}+T_{RP}+T_{RA,c}=T_{NA,c}+T_{meas,c} (1c)

come into effect. Here,

T_{NR} is the time elapsing after node 100a receives positioning signal S101 and until reference station 110 receives positioning signal S101,

T_{RP} is the time elapsing after reference station 110 receives positioning signal S101 and until it transmits reference signal S111,

T_{RA,a}, T_{RA,b}, and T_{RA}, are the times elapsing after reference station 110 transmits reference signal S111 and until base stations 120a, 120b, and 120c receive reference signal S111,

T_{NA,a}, T_{NA,b}, and T_{NA,c} are the times elapsing after node 100a transmits positioning signal S101 and until base stations 120a, 120b, and 120c receive positioning signal S101, and

T_{meas,a}, T_{meas,b}, and T_{meas,c} are the times elapsing after stations 120a, 120b, and 120c receive positioning signal S101 and until they receive reference signal S111.

Eq. 1a and Eq. 1b lead to the equation below:

T_{NA,a}−T_{NA,b}=(T_{RA,a}−T_{RA,b})−(T_{meas,a}−T_{meas,b}) (2)

Here, T_{RA,a} and T_{RA,b} are respectively equal to the distances between reference signal 110 and base stations 120a and 120b, divided by the speed of light. Also, since T_{meas,a} and T_{meas,b} are the values measured by respectively base stations 120a and 120b, the result is that the right-hand side of Eq. 2 is a known value.

Consequently, it is possible to calculate the difference in time T_{NA,a}−T_{NA,b} with which positioning signal S101 reaches base stations 120a and 120b. In the same way, since it is possible to learn the time difference of arrival to three base stations 120, it becomes possible, by the TDOA positioning method, to calculate the position of node 100a. Further, in the present invention, the number of base stations is taken to be 3, but, supposing two-dimensional coordinates are demanded, there is no problem in having any number of base stations, if there are three or more base stations.

FIG. 8 shows a configuration example of positioning signal S101 transmitted from node 100 and reference signal S111 transmitted from base station 110. The concerned signals S101 and S111 are composed of a preamble 310, a frame starting part (Start Frame Delimiter, hereinafter abbreviated as “SFD”) 320, a header 330, and data 340. Inside the header or inside the data, there may be included CRC (Cyclic Redundancy Check) code or the like.

Preamble 310 is used for the capture of synchronization in devices having received the concerned signals S101 and S111. SFD 320 is a specific bit pattern indicating the end of preamble 310 and the start of header 330. In header 330, there is stored information and the like about the identifier of the sender, the identifier of the intended recipient, and the like, of the concerned signals S101 and S111. In data 340, there is stored information from the send of the concerned signals S101 and S111.

By choosing the concerned signals S101 and S111 to be signals for communication, it becomes possible to carry out positioning simultaneously with communication. Also, the need to generate special signals for positioning in node 100 and reference station 110 disappears, so the devices are simplified.

The transmission time or the reception time of the concerned signals S101 and S111 is determined to be the time at which a certain specific portion is transmitted or received. E.g., the time at which the transmission of SFD 320 of the concerned signals S101 and S111 has been finished is determined to be the transmission time and the time at which reception thereof has been finished is determined to be the reception time.

In the present positioning system, the accuracy of the position of the measured node 100 depends on the accuracy of the time difference of arrival (TDOA), i.e. on the accuracy of the time Tₘₑₐₛ measured at base station 120. Moreover, the accuracy depends on the time measurement errors among the plurality of base stations 120a, 120b, and 120c. E.g., in order to obtain a positional accuracy of 30 cm, a time accuracy of approximately 1 ns becomes necessary. In case the time differences are measured with an accuracy of 1 ns, normally the signal reception timing is measured by carrying out a recording of the wave shape using 1 GHz A/D converters and memories. However, if there is used a high-speed A/D converter like this and a large-scale memory for recording the output thereof, the power consumption and the scale of the circuits end up increasing.

In the present embodiment, a comparatively low-speed oscillator and a low-speed counter are used and highly accurate time difference measurements are carried out while reducing the power consumption and the circuit scale.

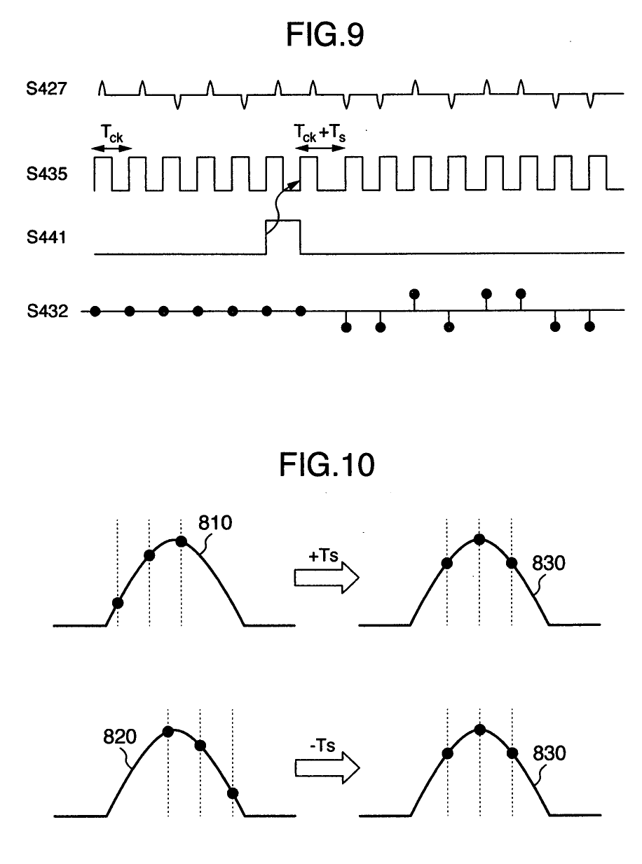

Hereinafter, the details thereof will be described using FIG. 9 to FIG. 11.

First, using FIG. 9, the synchronization capture method will be described. In case the phases of an impulse sequence S427 inputted into A/D conversion part 430 and a sampling clock S435 do not match, an output in which the pulses are sampled is outputted to a digital signal S432.

Digital signal S432 is inputted into baseband part 440 and a judgment is carried out as to whether the phases match or mismatch, from the level of the concerned signal S432. In case the phases do not match, a shift signal (with the timing shift time being equal to Tₛ) is generated and the phases are adjusted.

In other words, by outputting a sampling timing control signal S441 and shifting the period of sampling clock S435 to make it longer or shorter by a fixed time (Tₛ), the sampling timing is shifted. This processing is repeated until the phases of impulse sequence S427 and sampling clock S435 match. In this way, by shifting the phases of sampling timing control signal S441 and sampling clock S435, there is carried out the capture of synchronization with impulse sequence S427.

To the A/D converters 431ia, 431ib, and 431ic of A/D conversion part 430, there are e.g. supplied sampling clocks having respectively a delay difference of 0.5 ns. In other words, in case the Gaussian impulse signal has a width of 2 ns, this impulse signal is converted into digital values at positions which are 0.5 ns apart and outputted. These values converted into digital values at different positions are used for synchronization tracking.

Even if the synchronization capture has once been established, in case there exists a frequency deviation in the clocks of the transmitting device and the receiving device, synchronization difference gradually arises. With the UWB-IR method, there is a need to carry out synchronization with respect to impulses have short intervals, on the order of 2 ns. If the frequency accuracy of the crystal oscillator used for the clock generation of the transmitting device and the receiving device is high, synchronization tracking is unnecessary, but it turns out that a crystal oscillator with high accuracy is expensive. In order to aim at cost reductions, the system must be one that can receive even with a crystal oscillator having a low accuracy. As a result, the operation of synchronization tracking becomes necessary.

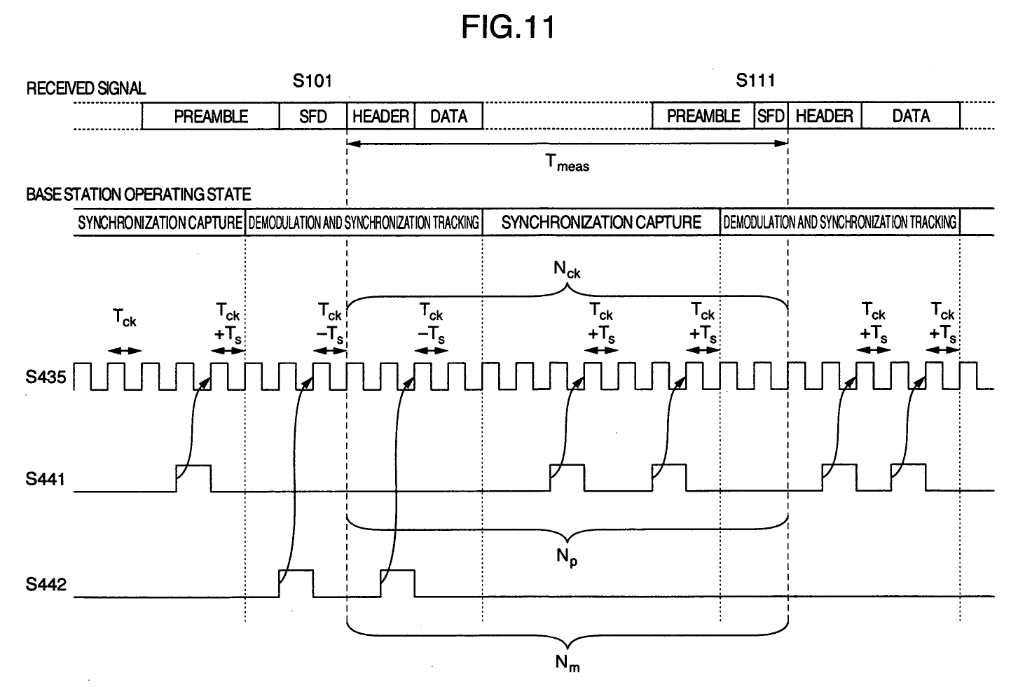

Regarding this synchronization tracking, a description is given in FIGS. 10 to 11, inclusive. FIG. 10 is a conceptual diagram of synchronization tracking and FIG. 11 shows the principle of time difference measurements.

First, in FIG. 10, from a state 830 in which the peak of a pulse is sampled, there arises a misalignment between the peak of the pulse and the sampling timing, due to frequency deviation, as shown in states 810 and 820.

In baseband part 440, this misalignment is detected using the analog-to-digital converted three-level digital signal S432 and the period of sampling clock S435 is adjusted through control signals S441 and S442. In other words, in case sampling clock S435 is leading with respect to the impulse as shown in state 810, the period of sampling clock S435 is made longer by a fixed time (Tₛ) by means of a shift signal. Also, in case sampling clock S435 is lagging with respect to the impulse as shown in state 820, the period of sampling clock S435 is made shorter by a fixed time (Tₛ) by means of a shift signal.

Sampling clock generating part 433 generates, as described above, sampling clocks S435ia to S435ic and S435qa to S435qc which determine the sampling timing of A/D converter 431, in response to sampling timing control signals S441 and S442 supplied from baseband part 440.

Baseband part 440 carries out, using received signal S432 converted into digital values, the signal processing of synchronization capture, synchronization check, signal demodulation, synchronization tracking, and time difference measurement, as well as the sampling timing control of A/D conversion part 430. Demodulated data S443 and positioning data S444 are outputted from the baseband part and communicated to higher layers, data processing being carried out in the higher layers.

Further, in the present embodiment, a 3 line by 2 channel input was processed in A/D conversion part 430 using A/D converters 431ia, 431ib, 431ic, 431qa, 431qb, and 431qc, but by taking the input type to be 2 lines by 2 channels, 431ib, 431ic, 431qb, and 431qc, and using the approximation that 431ia=(431ib, +431ib)/2 and 431qa=(431qb, +431qc)/2, it is possible to reduce the scale of the circuit.

Next, the principle of the time difference measurement will be explained while referring to FIG. 11. FIG. 11 is a timing chart of the receiving device of base station 120, at the time of receiving positioning signal S101 and reference signal S111. As long as the capture of the synchronization with positioning signal S101 is not established, capture of the synchronization is carried out by changing the synchronization of sampling clock S435 by means of sampling timing control signal S441. Positioning signal S101 is measured and if synchronization capture is established, demodulation and synchronization tracking is started.

Since there exists a frequency deviation between the transmitting device and the receiving device, even after synchronization has once been established, there occurs a gradual misalignment in the synchronization. With synchronization tracking part 560, the misalignment is detected and the period of sampling clock S435 is adjusted through control signals S441 and 442.

When the receiving device finishes receiving data 340 of positioning signal S101, it carries out synchronization capture. After the capture of the synchronization with reference signal S111 has been established, demodulation and synchronization tracking is carried out.

Base station 120, after receiving positioning signal S101, measures the time Tₘₑₐₛ until receiving reference signal S111. Here, the reception times of the concerned signals S101 and S111 are taken to be the times at which the reception of SFD 320 ends.

The period of sampling clock S435 is normally T_{ck}, the result being respectively T_{ck}+Tₛ or T_{ck}−Tₛ in case control signal S441 or S442 is output. If this is utilized, the reception time difference Tₘₑₐₛ of positioning signal 101 and reference signal S111 is given by the equation hereinafter:

Tₘₑₐₛ=T_{ck}·N_{ck}+Tₛ·(Nₚ−Nₘ) (3)

Note that:

T_{ck} is the normal sampling clock period,

Tₛ is the timing shift time,

N_{ck} is the number of clock counts for pulse sampling, and

Nₚ and Nₘ are the numbers of counts of +Tₛ and −Tₛ sampling timing control signals.

That is to say that the concerned reception time difference is computed by counting the number of sampling clocks S435 and control signals S441 and S442 therefor.

This reception time difference computation is performed with time difference and deviation measurement part (TD&FDMM) 580 (refer to FIG. 6). Next, there will be given a description of the operation of this time difference and deviation measurement part 580. A sampling clock S435D and sampling timing control signals S441 and S442 are inputted into time difference and frequency deviation measurement part 580. Clock S435D and control signals S441 and S442 are respectively inputted into counters 610a to 610c and the count values thereof are output as signals S611a to S611c.

SFD detection signal S551 is outputted from demodulation part 550 at the timing with which SFD 320 is detected. Count values S611a to S611c are stored in registers 620a to 620c at the SFD detection timing. Also, SFD detection signal S551 is delayed in delay part 630 and the count values of counters 610 are reset.

In time difference calculation part 640, the reception time difference Tₘₑₐₛ is calculated according to Eq. 3, using the values stored in registers 620. The concerned time difference Tₘₑₐₛ is outputted as signal S444a to higher-level layers. In the higher-level layers, the ID and the like of node 100 are identified from the demodulated data S443, and necessary information and the concerned reception time difference Tₘₑₐₛ are transmitted to the positioning server. In the positioning server, the position of node 100 is computed on the basis of data from the base station.

The calculation of the concerned reception time difference Tₘₑₐₛ may be carried out not in the time difference and deviation measuring part 580 but in higher-level layers, the positioning server, or the like.

Also, the measurement starting time and ending time of Tₘₑₐₛ need not be the SFD detection time. E.g., the measurement may start from the data ending time of positioning signal S101. In this case, the measurement time is shortened compared to the aforementioned example, so a reduction in the bit number of the counter becomes possible and the scale of the circuit is reduced.

In case synchronization capture is not established, sampling timing control signal S441 is outputted periodically. The reason is that a fixed time is needed to judge whether synchronization has been captured or not. If this is utilized, the number of sampling clocks S435d in this interval can be computed from the number of counts of sampling timing control signal S441.

The above is a method and circuit measuring the reception time difference Tₘₑₐₛ with high accuracy and low power consumption. That is to say that the number of sampling clocks S435 and sampling timing control signals S441 and S442 are counted and the concerned reception time difference Tₘₑₐₛ is computed according to Eq. 3.

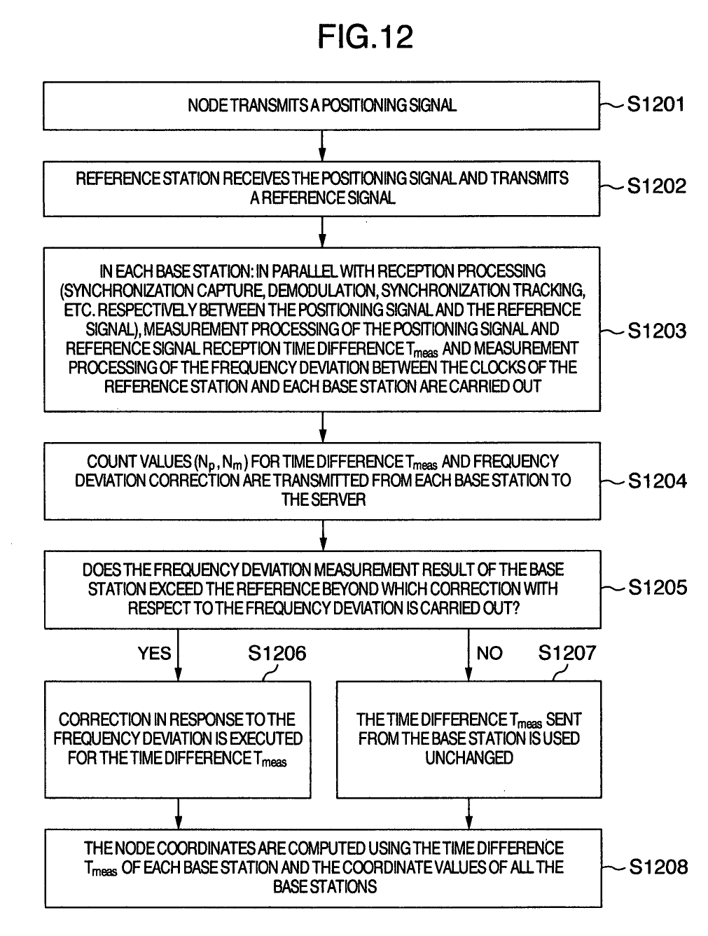

In FIG. 12, there is shown an overall flowchart of the positioning processing according to the present embodiment.

The node transmits a communication signal including positioning signal S101 with respect to reference stations 110 and base stations 120 in the surroundings at an arbitrary time when a position calculation, based on an instruction from the server, the track of a pre-set timer, or the like, is desired (S1201). Reference station 110 transmits a transmission signal including reference signal S111 after receiving the positioning signal (S1202).

Here, base station 120 carries out, at the time of receiving a transmission signal, e.g. positioning signal S101, the capture of the synchronization between this positioning signal and a sampling clock. After synchronization capture has been established, demodulation and synchronization tracking are carried out. Each base station carries out, in parallel with reception processing of transmissions signals such as synchronization capture, demodulation and synchronization tracking, measurement processing of the sampling timing control signal counts Nₚ and Nₘ used for the reception time difference Tₘₑₐₛ and frequency deviation correction of positioning signal S101 and reference signal S111 according to Eq. 3 (S1203). Regarding the correction of the frequency deviation and the measurements therefor, a detailed explanation will be given subsequently. Information based on these results is sent to server 130 (S1204). Server 130, on the basis of this information, judges whether or not to carry out a correction based on the frequency deviation with respect to the reception time difference measurement results from each base station (S1205). Regarding the aforementioned reference of judgment, it will be subsequently described.

If the measurement results fulfill the criterion for carrying out a correction, a correction suited to the frequency deviation is carried out with respect to the reception time difference measurement result Tₘₑₐₛ (S1206). Also, in case the criterion is not fulfilled, the reception time difference measurement results Tₘₑₐₛ sent from the base station are used unchanged (S1207). From the reception time difference measurement results Tₘₑₐₛ for which the aforementioned processing has been performed, and the information stored in the database held by the server, the coordinates of the node are computed and positioning is carried out (S1208).

In this way, by using a system of the present embodiment, provided with functions such as synchronization capture, synchronization tracking, and reception time difference measurements, even if there are used comparatively low-speed clocks, control signals, and counters, highly accurate time difference measurements become possible. The operating frequency of the counters is the same as the pulse repetition frequency (1/T_{ck}), being e.g. approximately 32 MHz. Since the operating frequency of the counters is low, it is possible to reduce the power consumption and circuit scale thereof. Moreover, since the SFD detection signal S551 indicating the measurement start and end of Tₘₑₐₛ is synchronized with the sampling clock, the design thereof is simplified.

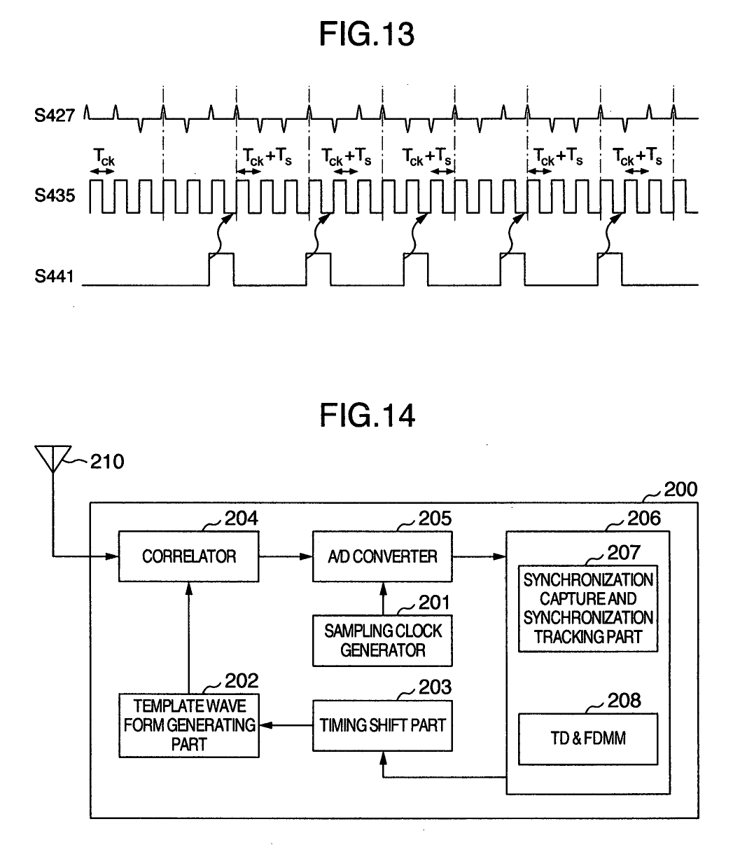

In FIG. 6 and FIG. 13, there will be given a description relative to the measurement of the frequency deviation which measures and reduces the mutual clock error between base stations.

In aforementioned Embodiment 1 of the invention, there is included in the concerned reception time difference Tₘₑₐₛ measured by base station 120 an error resulting from the lack of frequency precision of the clock.

In positioning server, using the Tₘₑₐₛ values measured by a plurality of base stations 120, the position of node 100 is computed according to Eq. 2. In case the error of the clock is taken into account, the second term on the right-hand side of Eq. 2 becomes

T_{meas,a}−T_{meas,b}=T_{real,a}·(1+δₐ)−T_{real,b}(1+δ_{b})=

=T_{real,a}−T_{real,b}+(T_{real,a}·δₐ−T_{real,b}·δ_{b}) (4)

there arising an error (T_{real,a}·δₐ−T_{real,b}·δ_{b}) Here, T_{real,a}, T_{real,b} are the actual times that should respectively be measured by base stations 120a and 120b and

δₐ and δ_{b} are the deviations of the clocks of base stations 120a and 120b. The error (T_{real,a}·δₐ−T_{real,b}·δ_{b}) is transformed into

T_{real,a}·δₐ−T_{real,b}·δ_{b}=

=(T_{real,a}−T_{real,b})·δₐ+T_{real,b}·(δₐ−δ_{b}) (5)

The (T_{real,a}−T_{real,b}) value depends on the distance between node 100 and base stations 120, and the distance between reference station 110 and base stations 120. E.g., if a positioning system with a width of 30 meters square is considered, the result is that the value is at most on the order of 100 ns. As against this, the T_{real,b} value depends on the signal processing time in reference station 110, the data length of positioning signal S101, the preamble length of reference signal S111, and the like, the value being at least 0.6 ms or greater in the case where e.g. the preamble length is 20 bytes at a transmission speed of 250 kbps. In this case, if e.g. the deviation (δₐ−δ_{b}) in the clocks among the base stations is taken to be 20 ppm, there occurs a time error of approximately 13 ns. This works out to an error of 4 m when converted into distance.

Consequently, among the errors expressed in Eq. 5, it is the second term that becomes the dominant one. In other words, that a primary factor of error is not the absolute deviation of the clocks (the deviation from the actual time) but the relative clock deviation between the base stations. Consequently, the error is reduced if the relative clock deviation among the base stations is reduced.

In the present embodiment, the server, in Step S1206 of FIG. 12, measures the frequency deviation between the clocks of the base station and reference station and carries out a reduction in the positioning error by adjusting the clocks of each base station to the clock of the reference station. That is to say that the clock frequency of the reference station is taken as a reference and the mutual base station clock error is measured and reduced. Using FIG. 13, the operating principle of the frequency deviation measurement unit is described.

FIG. 13 is a timing chart of A/D conversion part 430 of base station 120a, occurring at the time of reception of reference signal S111. It shows the state after establishing synchronization with reference signal S111. In this state, analog signal S427 inputted into A/D conversion part 430 and sampling clock S435 are synchronized. In other words, the synchronization of sampling clock S435 is controlled, by means of sampling timing control signals S441 and S442, so as to be synchronized with the concerned analog signal 432.

Also, since reference signal S111 is generated by means of reference station 110, the concerned analog signal S432 is reflective of the frequency deviation of the clock of reference station 110. Consequently, the output period of control signal S441 corresponds to the deviation between the clock of base station 120a and the clock of reference station 110. The deviation is expressed as

δₐ−δᵣ=Tₛ·(Nₚ−Nₘ)/T_{ck}·N_{ck} (6)

Here, δᵣ is the deviation of the clock of reference station 110.

That is to say that the frequency deviation (δₐ−δᵣ) is computed by counting sampling clock S435 and sampling timing control signals S441 and S442. By this method, the error resulting from the frequency deviation of the clocks is reduced by means of the fact that the server computes, in Step S1206, the deviation with respect to each base station 120 and reference station 110, and carries out a correction taking as reference the clock frequency of the reference station.

In this way, due to the fact that the error resulting from the frequency deviation of the clocks is reduced, it is possible to improve the positioning accuracy.

However, in case the number of Nₚ and Nₘ samples is too small because the measurement time of the clock frequency deviation between the base stations and the reference station was too short, there can be considered cases in which the deviation obtained by Eq. 6 and the actually deviation do not match. In the case of e.g. looking at this statistically, in order for the confidence interval that the error is 20 percent or less of 90 percent, it is necessary that Nₚ+Nₘ>17. In case only this number or less of samples can be obtained, there is a high probability that there is some error included in the deviation obtained by Eq. 6, so by carrying out a correction of the error accompanying the clock deviation, it can be considered that the error in the measurement result of the reception time difference (T_{real,a}−T_{real,b}) on the contrary ends up getting increased.

For this reason, the system is devised so that it judged whether Nₚ+Nₘ is equal to or smaller than a fixed value, and in case the sum is equal to or smaller than the fixed value, no correction of the clock is carried out. It is possible to maintain a high accuracy by providing the judgment of not carrying out a correction if Nₚ+Nₘ is equal to or less than 17 and carrying out a correction if the sum is greater than 17, to prevent an increase in the error due to an inaccurate correction. Also, the fact of taking the reference of the judgment by which the correction is carried out to the single value of Nₚ or Nₘ or the time to measure these values falls under the category of the present invention. In other words, depending on whether the number of samples (the number of times of output of the control signal) used when computing the clock frequency deviation and the measured time fulfills a prescribed condition, it is possible to improve the measurement accuracy by judging whether it is necessary to make a correction or not on the basis of the clock frequency deviation. Further, regarding the threshold value for judging whether it is necessary to make a correction, it varies with changes in parameters such as the length of the confidence interval for which the error described above becomes equal to or smaller than a prescribed value.

Next, there will be given a description regarding the operation of the time difference and deviation measurement part 580 during frequency deviation measurements in FIG. 6.

For the frequency deviation measurements, there are used counters 610, registers 620, and deviation calculation part (FDCAL) 650 of time difference and deviation measurement part 580. Into time difference and deviation measurement part 580, there are input sampling clock S435D, sampling timing control signals S441 and S442, SFD detection signal S551, and data ending signal S552, and a measured deflection S444b is outputted. Data ending signal S552 is outputted from the demodulation part the moment data 340 of the received signal have come to an end.

Clock S435D and control signals S441 and S442 are respectively inputted into counters 610a to 610c and the count values thereof are outputted as signals S611a to S611c. The concerned count values S611a to S611c are reset at the SFD output timing and are stored at data ending timing in registers 620d to 620f. In deviation measurement part 650, according to Eq. 6, the deviation is computed using the values of registers 620.

The upper layers or the positioning server investigate whether or not to carry out a correction, taking into account the contents of the clock count values Nₚ or Nₘ for correction and in response thereto carry out a correction of the error due to the clock deflection of the received time difference Tₘₑₐₛ. Thereafter, the positioning server computes the position of node 100 using the reception time difference Tₘₑₐₛ.

Here, it was chosen to carry out a correction of the deviation using reference signal S111, but the invention is not limited thereto, it being acceptable to use positioning signal S101 from the node, a signal from another transmitting device, or the like. Also, the timing with which the deviation is measured is not limited to the timing at which positioning is carried out and the measurement may take place at some appropriate time such as at the moment of installation, at regular intervals, or when a change in temperature has occurred. At this point, the concerned deviation data are stored in base station 120, in the database of positioning server 130, or the like.

As mentioned above, after establishment of the synchronization capture, by measuring the number of times that control signals S441 and S442 are outputted and comparing the measurement result with pre-set conditions, and after judging whether a valid correction can be carried out, a correction of the deviation is performed. In this way, the positioning accuracy is improved. Also, if an appropriate deviation correction becomes possible, the range of positioning possibility is extended. In order to extend the range in which positioning is possible, communications with long communication distances and low transmission speeds become necessary. At a low transmission speed, the measured time difference Tₘₑₐₛ becomes long since the preamble length is great and the error resulting from the frequency deviation increases. By means of a correction of the deviation, this error can be reduced, so positioning at low transmission speeds becomes possible and it is possible to extend the positioning range. Also, the use of crystal oscillators with a large frequency deviation and a low price becomes possible, so the cost can be reduced.

In order to be able to cancel the error due the individual clock accuracies by the aforementioned method, the time measurement accuracy of this method becomes □Tₛ (timing shift time). E.g., if Tₛ is taken to be 0.5 ns, it becomes the same accuracy as in the case of making measurements using 1 GHz oscillators and counters, making it possible to obtain a positioning accuracy of approximately 30 cm.

As described above, in the receiving device of a base station related to the present embodiment, it is possible, for the measurement of the reception time difference between the positioning signal and the reference signal, to use a control signal shifting the phase of a low-speed clock and the concerned clock. And then, the occurrencies of this clock and the concerned control signal are counted with a low-speed counter and the reception time difference is computed. The accuracy of the computed reception time difference is decided by the time of shifting by means of one control signal generation. For this reason, highly accurate time difference measurements become possible. By carrying out measurements of reception time differences using this method, high-speed clocks and high-speed counters are not needed and the power consumption and circuit scale are reduced.

In the aforementioned positioning detection system, the network communicating the information about the base stations to the server may be wireline or wireless. Also, it is also possible for a base station to combine the functions of reference station and server. That is to say that it is possible that, if the base station receives a positioning signal, it transmits a reference signal when the time difference and deviation measurement part of the base station, on the basis of the measurement result of the clock frequency deviation, performs a judgment on whether or not to carry out a correction of the reception time difference between the positioning signal and the reference signal, and in case it is judged that a correction will be carried out, carries out a correction of the reception time difference. In this way, it is possible to diminish the load of the server.

Also, it becomes possible to load a positioning function in the receiving device as a standard. That is to say that all the nodes having a receiving function can become base stations for positioning, so a flexible positioning system is formed.

In this way, by carrying out a correction of the deviation of the mutual clock of the base stations, the error of the time difference measurement can be reduced and positioning with low transmission speeds becomes possible, so it is possible to extend the scope of positioning. Also, the use of crystal oscillators with large frequency deviation and a low price becomes possible, so the cost can be reduced.

This far, there was carried out a description regarding a system such as shown in FIG. 1, composed of nodes 100, a reference station 110, base stations 120, and a positioning server 130, but the time difference measurement method and the deviation measurement method related to the present invention would also exhibit an effect in another system with a different configuration.

E.g., even in the case of measuring the distance between two communication devices, the method related to the present invention is valid. In case the first communication device transmits a positioning signal to the second communication device and the second communication device having received the positioning signal transmits a reply signal to the first communication device, the distance is computed due to the fact that the first communication device measures the time until the reply signal is received after transmitting a positioning signal. If a receiving device according to the present invention is used, it is possible to measure this time difference from the clock or the control signal of the concerned clock, so the distance between two communication devices is computed with high accuracy.

Also, since the processing time in the second communication device is included in the time measured as described above, in case a deviation exists in the clocks of the two communication devices, it becomes a primary factor of error at the time of computing the distance. In the method related to the present invention, by measuring the deviation and correcting it, the error in the measured distance is reduced.

Moreover, the frequency deviation measurement unit of this embodiment can be used not only for a positioning system but also for the maintenance of constituent equipment of a receiving device utilizing frequency deviation measurement results.

### Second Embodiment

Also, as an example of a receiving device in a base station, the description was carried out using a device making an analog-to-digital conversion of a received impulse sequence with the pulse repetition period, but the time difference measurement method and the deviation measurement method related to the present invention are not ones limited to this device.

E.g., as a positioning system of Embodiment 2 of the present invention, it is valid to adopt, for a communication system using a method of taking the correlation between a template wave shape and a received signal and capturing the synchronization thereof, a receiving device using a time difference and deviation measurement method similar to that of Embodiment 1.

In FIG. 14, there is shown a configuration example of a receiving device 200 related to Embodiment 2 of the present invention. The receiving device is provided with: a template wave form generating part 202; a timing shift part 203 shifting the timing (phase) generating this template wave form; a correlator 204 taking the correlation between this template wave form and a received signal received via an antenna 210; an A/D converter 205 making an analog-to-digital conversion of the output signal of this correlating part; a sampling clock generator 201 supplying the timing of this A/D conversion; and a pseudo-random code generating part (illustration omitted). Further, a baseband part (BBM) 206 is provided with a synchronization capture and synchronization tracking part 207 and a time difference and frequency deviation measurement part (TD&FDMM) 208 and carries out synchronization capture and synchronization tracking between a received signal and the template wave form and further performs clock deviation corrections and carries out position or distance measurements.

In template wave form generating part 202, a template wave form is generated using a pseudo-random code used for the spread of signals on the transmission side of the communication system. In correlator 204, the correlation between this template wave form and a received signal is taken and sent to baseband part (BBM) 206 via A/D converter 205. In synchronization capture and synchronization tracking part 207, there is detected, while controlling the generation timing of the template wave form, the time at which the correlation between the received signal and the template wave form is the highest. After this, the timing with which the template wave form is generated is controlled so that the aforementioned correlation is maintained high.

Synchronization capture and synchronization tracking part 207 and time difference and frequency deviation measurement part (TD&FDMM) 208 have synchronization capture and synchronization tracking functions, such as described in Embodiment 1, shifting the phase of the template wave form, and a reception time difference measurement function or a deviation measurement function. In this way, by counting the occurrence of signals controlling timing shift part 203 and the sampling clocks of the A/D converter in time difference and frequency deviation measurement part (TD&FDMM) 208, highly accurate time difference measurements and deviation measurements become possible.

According to the present embodiment, highly accurate time difference measurements and clock deviation corrections become possible in a small-size and low-cost device and highly accurate positioning is implemented.

### Third Embodiment

Further, this far, there has been carried out a description of a time difference measurement method for transmission signals from different transmitting devices, but the time difference measurement method of the present invention is not limited thereto. E.g., in case a first transmission signal and a second transmission signal are transmitted from the same transmitting device, it is valid to adopt a receiving device using a time difference and deviation measurement method similar to that of Embodiment 1.

In this case, the time difference measured in the receiving device corresponds to the distance moved after the transmitting device has transmitted the first transmission signal until the second transmission signal is transmitted. That is to say that by receiving, with a receiving device related to the present invention, the first transmission signal and the second transmission signal transmitted from the same transmitting device, it becomes possible to measure a relative variation in the distance or variation in the position. Moreover, by carrying out a correction of the clock frequency deviation by means of the deviation measurement method related to the present invention, highly accurate measurements become possible.

It should be further understood by those skilled in the art that although the foregoing description has been made on embodiments of the invention, the invention is not limited thereto and various changes and modifications may be made without departing from the spirit of the invention and the scope of the appended claims.

1. A positioning system consisting of:
a node transmitting a positioning signal;
a reference station transmitting a reference signal;
at least three base stations having a receiving part receiving said positioning signal and said reference signal and a time difference and deviation measurement part measuring the reception time difference of said positioning signal and said reference signal, and computing the clock frequency deviation with said node or said reference station; and
a server having a database storing position information about said reference station and said base stations and a positioning part computing the position of said node using said position information and said reception time differences;
and carrying out a judgment of whether to perform a correction of said reception time differences based on said clock frequency deviation and wherein, in case it is judged that said correction should be carried out, said positioning part computes the position of said node, using the reception time differences for which said correction has been carried out.

2. The positioning system according to claim 1, wherein said base stations carry out a judgment of whether to perform a correction of said reception time differences based on said clock frequency deviation and, in case it is judged that said correction should be performed, carry out a correction of said reception time differences and transmit the reception time differences for which said correction has been carried out to the server.

3. The positioning system according to claim 1, wherein said server carries out a judgment of whether to perform a correction of said reception time differences based on said clock frequency deviation and, in case it is judged that said correction should be carried out, carries out a correction of said reception time differences.

4. The positioning system according to claim 1, wherein said judgment is that, in case the number of counts of the sampling timing control signal changing the sampling period of said positioning signal and said reference signal is equal to or smaller than a prescribed value, said correction is not carried out, and in case said prescribed value is exceeded, said correction is carried out.

5. The positioning system according to claim 4, wherein said prescribed value is 17.

6. The positioning system according to claim 1, wherein said judgment is that, in case the measurement time of said clock frequency deviation is equal to or smaller than a prescribed value, said correction is not carried out, and in case said prescribed value is exceeded, said correction is carried out.

7. A base station having:
a receiving part receiving a positioning signal transmitted from said node and a reference signal transmitted from said reference station; and
a time difference and deviation measurement part measuring the reception time difference between said positioning signal and said reference signal, computing the clock frequency deviation with said node or said reference station, carrying out a judgment of whether perform a correction of said reception time difference based on the clock frequency deviation, and, in case it is judged that said correction should be carried out, carrying out a correction of said reception time difference; and
transmitting the measurement result computed in said time difference and deviation measurement part to the server computing the position of said node, using position information about said reference station and said base station and the reception time difference for which said correction has been carried out.

8. The base station according to claim 7, wherein said judgment is that, in case the number of counts of the sampling timing control signal changing the sampling period of said positioning signal and said reference signal is equal to or smaller than a prescribed value, said correction is not carried out, and in case said prescribed value is exceeded, said correction is carried out.

9. The base station according to claim 8, wherein said prescribed value is 17.

10. The base station according to claim 7, wherein said judgment is that, in case the measurement time of said clock frequency deviation is equal to or smaller than a prescribed value, said correction is not carried out, and in case said prescribed value is exceeded, said correction is carried out.
